(19) United States
(12) Patent Application Publication
(10) Pub. No.: US 2025/0038843 A1
(43) Pub. Date: Jan. 30, 2025

(54) TERMINAL APPARATUS, COMMUNICATION METHOD, AND PROGRAM

(71) Applicant: NIPPON TELEGRAPH AND TELEPHONE CORPORATION, Tokyo (JP)

(72) Inventors: Hiroshi OIWA, Tokyo (JP); Hiroshi YOSHIDA, Tokyo (JP)

(73) Assignee: NIPPON TELEGRAPH AND TELEPHONE CORPORATION, Tokyo (JP)

(21) Appl. No.: 18/709,027

(22) PCT Filed: Nov. 26, 2021
(86) PCT No.: PCT/JP2021/043387

§ 371 Date: May 10, 2024

(51) Int. Cl. H04B 10/079; H04Q 11/00

(52) U.S. Cl. CPC H04B 10/0791; H04Q 11/0067

(57) ABSTRACT

According to an aspect of the present invention, there is provided a terminal station device in a passive optical communication network in which the terminal station device and a subscriber line termination device are connected to each other, the terminal station device including: a distance measurement unit that measures a distance between the terminal station device and the subscriber line termination device; a signal intensity measurement unit that measures an intensity of a signal received from the subscriber line termination device; and an estimation unit that estimates an occurrence of a sign of a failure in the subscriber line termination device based on a measurement result of the distance by the distance measurement unit and a measurement result of the intensity of the signal by the signal intensity measurement unit.

### TECHNICAL FIELD

An embodiment of the present invention relates to a terminal station device, a communication method, and a program.

### BACKGROUND ART

In a passive optical network (PON) (refer to, for example, Non Patent Literatures 1 and 2) in which a terminal station device and a plurality of subscriber line termination devices are connected to each other, the terminal station device being an in-station communication device of a communication line provider (sometimes referred to as a line provider), the subscriber line termination device is an in-home communication device installed in a home of a user who receives a communication service from the communication line provider. Thus, the communication line provider cannot freely access the subscriber line termination devices.

On the other hand, in a case where a failure or the like of the subscriber line termination device occurs, it is necessary for the line provider to quickly perform recovery work such as repair or replacement of the subscriber line termination device.

### CITATION LIST

### Non Patent Literature

Non Patent Literature 1: NTT Access Network Service Systems Laboratories, “Technical basic course [GE-PON Technologies] Part 2 IEEE 802.3ah Standard”, NTT Technical Journal (NTT Technical Review) 2005.9, pp. 91-94.
Non Patent Literature 2: NTT Access Network Service Systems Laboratories, “Technical basic course [GE-PON Technologies] Part 4 System Construction Functions for GE-PON”, NTT Technical Journal 2005.11, pp. 59-61.

### SUMMARY OF INVENTION

### Technical Problem

On the other hand, currently, a terminal station device detects a failure or the like of a subscriber line termination device by detecting an abnormality in a connection state of a communication line (sometimes simply referred to as a line) between the terminal station device and the subscriber line termination device or detecting a failure or the like of the subscriber line termination device by using a self-monitoring function of the subscriber line termination device and notifying the terminal station device of the detected failure or the like.

In response to the detection, the terminal station device notifies a management system of the line provider of a failure or the like of the subscriber line termination device. After receiving this notification, the line provider can perform the recovery work for the first time.

In this way, in a case where the recovery work is performed after detection of a failure or the like of the subscriber line termination device, there is a period during which provision of the communication service to the user is stopped until the recovery work is completed.

The present invention has been made in view of the above circumstances, and an object of the present invention is to provide a terminal station device, a communication method, and a program capable of reducing an influence on a communication service due to a failure of a subscriber line termination device.

### Solution to Problem

According to an aspect of the present invention, there is provided a terminal station device in a passive optical communication network in which the terminal station device and a subscriber line termination device are connected to each other, the terminal station device including: a distance measurement unit that measures a distance between the terminal station device and the subscriber line termination device; a signal intensity measurement unit that measures an intensity of a signal received from the subscriber line termination device; and an estimation unit that estimates an occurrence of a sign of a failure in the subscriber line termination device based on a measurement result of the distance by the distance measurement unit and a measurement result of the intensity of the signal by the signal intensity measurement unit.

According to another aspect of the present invention, there is provided a communication method performed by a terminal station device in a passive optical communication network in which the terminal station device and a subscriber line termination device are connected to each other, the method including: measuring a distance between the terminal station device and the subscriber line termination device; measuring an intensity of a signal received from the subscriber line termination device; and estimating an occurrence of a sign of a failure in the subscriber line termination device based on a measurement result of the distance and a measurement result of the intensity of the signal.

### Advantageous Effects of Invention

According to the present invention, it is possible to reduce an influence on a communication service due to a failure of a subscriber line termination device.

### BRIEF DESCRIPTION OF DRAWINGS

FIG. 1 is a diagram illustrating an application example of a communication system according to an embodiment of the present invention.

FIG. 2 is a diagram illustrating an example of conditions for estimating a deterioration of a subscriber line termination device in a table format.

FIG. 3 is a flow chart illustrating an example of a procedure of processing related to estimation of a deterioration of a subscriber line termination device.

FIG. 4 is a block diagram illustrating an example of a hardware configuration of a terminal station device of the communication system according to the embodiment of the present invention.

### DESCRIPTION OF EMBODIMENTS

Hereinafter, an embodiment according to the present invention will be described with reference to the drawings.

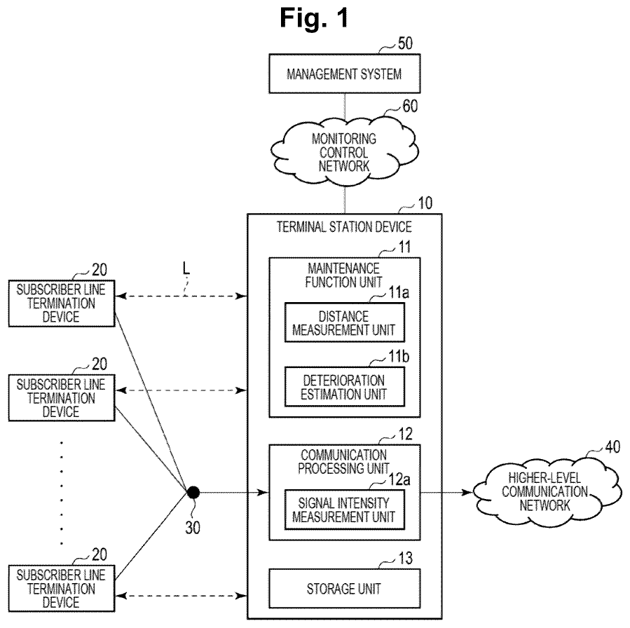

FIG. 1 is a diagram illustrating an application example of a communication system according to an embodiment of the present invention.

As illustrated in FIG. 1, a communication system according to an embodiment of the present invention includes a terminal station device 10 and a plurality of subscriber line termination devices 20. The terminal station device 10 is an optical line terminal (OLT) in a station of a line provider, and the subscriber line termination device 20 is an optical network unit (ONU) in a home of a user who receives a communication service from the line provider.

The terminal station device 10 and the subscriber line termination device 20 are communicably connected to each other by a relay network 30 which is an optical communication network using an optical fiber cable and an optical splitter. Thereby, a passive optical communication network is configured. The optical fiber cable is also simply referred to as an optical cable.

In addition, the terminal station device 10 is communicably connected to a higher-level communication network 40 in the communication system. Further, the terminal station device 10 is communicably connected to a management system 50 of a communication line provider via a monitoring control network 60 which is a communication network for monitoring control in the communication system.

The terminal station device 10 includes a maintenance function unit 11, a communication processing unit 12, and a storage unit 13.

The maintenance function unit 11 includes a distance measurement unit 11a and a deterioration estimation unit 11b.

The distance measurement unit 11a outputs a control signal for measuring a cable length between the terminal station device 10 and the subscriber line termination device 20, that is, a distance that is a length of an optical cable, to each of the plurality of subscriber line termination devices 20 via the communication processing unit 12, and measures a distance of a communication path between the terminal station device 10 and the subscriber line termination device 20 that is a transmission destination of the control signal for each of the subscriber line termination devices 20 based on a time required for transmission and reception of the output control signal.

The communication processing unit 12 includes a signal intensity measurement unit 12a. The signal intensity measurement unit 12a measures an intensity of the optical signal that is transmitted from the plurality of subscriber line termination devices 20, is propagated through the optical fiber cable, and is received by the terminal station device 10 for each of the subscriber line termination devices 20 as a transmission source.

Based on the measurement result of the distance by the distance measurement unit 11a and the measurement result of the intensity of the optical signal by the signal intensity measurement unit 12a, in a case where these measurement results satisfy a condition stored in the storage unit 13 that is to be described later, the deterioration estimation unit 11b estimates that a deterioration, which is a sign of a failure or the like, occurs in an optical transmitting module (sometimes referred to as a transmitting module) of the subscriber line termination device 20 related to the measurement results, that is, that the subscriber line termination device 20 will likely fail in the near future. The deterioration estimation unit 11b outputs a signal indicating the estimation result to the management system 50 via the monitoring control network 60.

Thereby, the communication line provider can recognize that the deterioration occurs in the transmitting module of the subscriber line termination device 20, and perform maintenance work before a failure of the subscriber line termination device 20.

In the present embodiment, the deterioration means a state where communication between the terminal station device 10 and the subscriber line termination device 20 can be performed at the present time but there is a relatively high possibility that a failure or the like of the subscriber line termination device 20 will occur thereafter and communication between the terminal station device 10 and the subscriber line termination device 20 cannot be performed due to the occurrence of the deterioration.

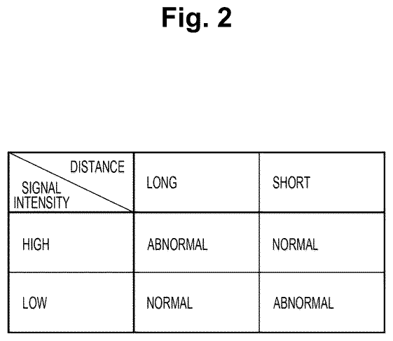

FIG. 2 is a diagram illustrating an example of conditions for estimating a deterioration of the subscriber line termination device in a table format.

The storage unit 13 of the terminal station device 10 stores pieces of information in a table format that indicate conditions for estimating a deterioration of the subscriber line termination device 20 as illustrated in FIG. 2.

In the table illustrated in FIG. 2, as a first condition, in a case where the distance (L in FIG. 1), which is the cable length between the terminal station device 10 and the subscriber line termination device 20, is equal to or longer than a normal distance, for example, a predetermined distance longer than a distance at a time of cable laying, and the intensity of the optical signal transmitted from the subscriber line termination device 20 and received by the terminal station device 10 is equal to or higher than a normal intensity, for example, a predetermined intensity higher than an intensity of the optical signal at a time of installation of the subscriber line termination device 20, the deterioration estimation unit 11b estimates that a deterioration occurs in the transmitting module of the subscriber line termination device 20.

The predetermined distance longer than the normal distance is, for example, a distance longer than the normal distance by approximately 0.01 [%].

The predetermined intensity higher than the normal intensity is, for example, an intensity higher than the normal intensity by approximately 1 [db].

The cable length between the terminal station device 10 and the subscriber line termination device 20 may change due to, for example, an aging deterioration of tension related to the cable or an increase in a temperature change cycle related to the cable.

In addition, the intensity of the optical signal transmitted from the subscriber line termination device 20 and received by the terminal station device 10 may change due to, for example, an abnormal operation of the transmitting module of the subscriber line termination device 20.

Further, in the table illustrated in FIG. 2, as a second condition, in a case where the distance between the terminal station device 10 and the subscriber line termination device 20 is equal to or shorter than a predetermined distance shorter than the normal distance and the intensity of the optical signal transmitted from the subscriber line termination device 20 and received by the terminal station device 10 is equal to or lower than a predetermined intensity lower than the normal intensity, the deterioration estimation unit 11b estimates that a deterioration occurs in the transmitting module of the subscriber line termination device 20.

The predetermined distance shorter than the normal distance is, for example, a distance shorter than the normal distance by approximately 0.01 [%].

The predetermined intensity lower than the normal intensity is, for example, an intensity lower than the normal intensity by approximately 1 [db].

In a case where neither the first condition nor the second condition is satisfied, the deterioration estimation unit 11b estimates that a deterioration, which is a sign of a failure or the like, does not occur in the transmitting module of the subscriber line termination device 20 or that a possibility of an occurrence of a deterioration is relatively low. On the other hand, in a case where the first condition or the second condition is satisfied, the deterioration estimation unit 11b estimates that a deterioration, which is a sign of a failure or the like, occurs in the transmitting module of the subscriber line termination device 20 or that a possibility of an occurrence of a deterioration is relatively high.

The estimation using the table is based on a relationship between the cable length between the terminal station device 10 and the subscriber line termination device 20 and the intensity of the optical signal transmitted from the subscriber line termination device 20 and received by the terminal station device 10.

The intensity of the optical signal transmitted through the optical fiber cable is attenuated in proportion to the distance that is the cable length.

In addition, in the optical transmitting module of the subscriber line termination device 20, the output intensity of the optical signal changes due to an aging deterioration or for other reasons. As a result, the optical transmitting module is finally in a failure state. In many cases, the output intensity of the optical signal is lowered due to an aging deterioration.

From the above, in a case where the intensity of the optical signal is decreased while the cable length is short, or in a case where the intensity of the optical signal is increased while the cable length is long, it is considered that the transmitting module of the subscriber line termination device 20 is deteriorated or a possibility of a deterioration of the transmitting module is relatively high. Thus, it is considered that there is a relatively high possibility that a failure or the like of the subscriber line termination device 20 will occur in the near future and communication between the terminal station device 10 and the subscriber line termination device 20 cannot be performed due to the occurrence of the failure.

Therefore, in the present embodiment, by comparing the distance between the terminal station device 10 and the subscriber line termination device 20 and the intensity of the optical signal transmitted from the subscriber line termination device 20 and received by the terminal station device 10 with the table illustrated in FIG. 2, the deterioration estimation unit 11b estimates the presence or absence of a possibility of a deterioration of the transmitting module of the subscriber line termination device 20.

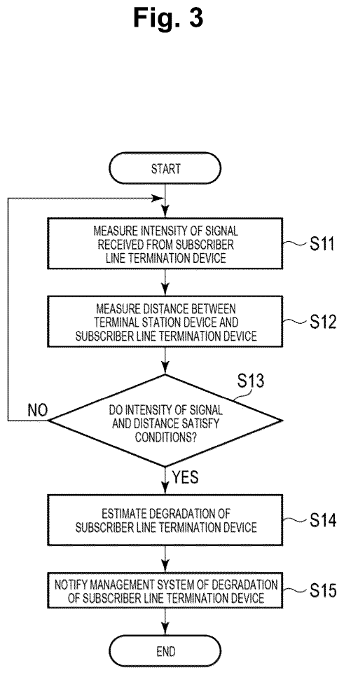

FIG. 3 is a flow chart illustrating an example of a procedure of processing related to estimation of a deterioration of the subscriber line termination device.

At a predetermined timing, the distance measurement unit 11a of the maintenance function unit 11 of the terminal station device 10 outputs the control signal to each of the plurality of subscriber line termination devices 20 via the communication processing unit 12, and measures the distance between the terminal station device 10 and the subscriber line termination device 20 as a transmission destination of the control signal, for each of the subscriber line termination devices 20, based on a time required for transmission and reception of the output control signal (S11).

The signal intensity measurement unit 12a of the communication processing unit 12 of the terminal station device 10 measures an intensity of the optical signal that is propagated through the optical cable from the plurality of subscriber line termination devices 20 and is received by the terminal station device 10 for each of the subscriber line termination devices 20 as a transmission source of the optical signal (S12).

The deterioration estimation unit 11b of the maintenance function unit 11 determines whether or not the first condition or the second condition related to a deterioration, which is a sign of a failure or the like, is satisfied in the optical transmitting module of the subscriber line termination device 20 related to the measurement results among the plurality of subscriber line termination devices 20 (S13), by comparing the measurement result of the distance in S11 and the measurement result of the intensity of the optical signal in S12 with the table stored in the storage unit 13 and illustrated in FIG. 2.

In a case where neither the first condition nor the second condition is satisfied (NO in S13), the deterioration estimation unit 11b estimates that a deterioration does not occur in the optical transmitting module of the subscriber line termination device 20 related to the measurement results or a possibility of an occurrence of a deterioration is relatively low, and returns to S11.

On the other hand, in a case where the first condition or the second condition is satisfied (YES in S13), the deterioration estimation unit 11b estimates that a deterioration occurs in the optical transmitting module of the subscriber line termination device 20 related to the measurement results or a possibility of an occurrence of a deterioration is relatively high (S14).

With the estimation in S14, the maintenance function unit 11 outputs a signal indicating an estimation result that a deterioration occurs in the optical transmitting module of the subscriber line termination device 20 related to the measurement results or that a possibility of an occurrence of a deterioration is relatively high to the management system 50 via the monitoring control network 60, and causes a display device (not illustrated) of the management system 50 to display the signal (S15).

As described above, the communication system according to the present embodiment measures the distance that is the length of the optical fiber cable between the terminal station device 10 and the subscriber line termination device 20, measures the intensity of the optical signal received by the terminal station device 10 from the subscriber line termination device 20 via the optical fiber cable, and estimates that a deterioration as a sign of a failure occurs in the transmitting module of the subscriber line termination device 20 or a possibility of an occurrence of a deterioration is relatively high based on the measurement result of the distance and the measurement result of the intensity of the optical signal. Thereby, it is possible to precisely predict an abnormality of the subscriber line termination device 20 as compared with, for example, a case where a failure of the subscriber line termination device is detected based only on a change in the intensity of the optical signal transmitted from the subscriber line termination device 20 and received by the terminal station device 10 as in the past.

As described above, by predicting a sign of a failure, the subscriber line provider can continue the communication service by repairing or replacing the subscriber line termination device 20 before a failure occurs. As described above, by repairing or replacing the subscriber line termination device 20 before a failure of the subscriber line termination device 20 occurs, a period for which the communication service for the user is influenced is within a period required for repairing or replacing the subscriber line termination device 20. Thus, an influence on the communication service for the user can be minimized.

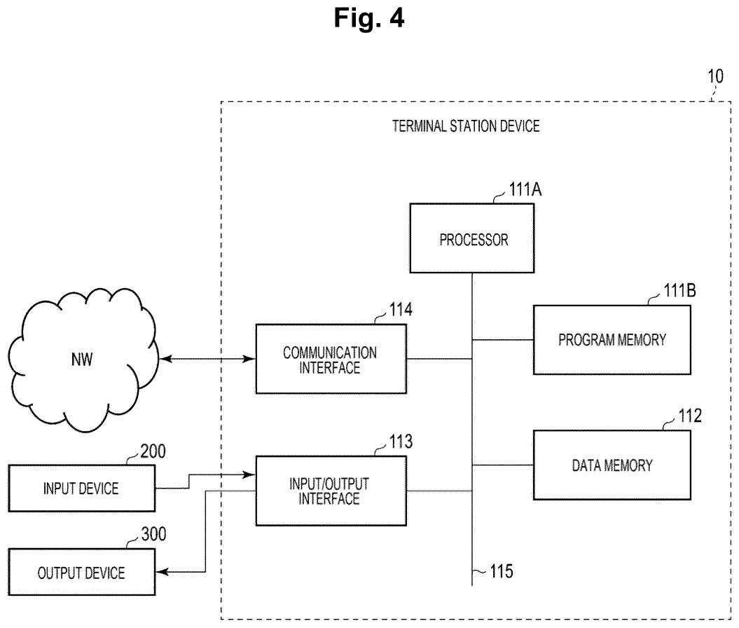

FIG. 4 is a block diagram illustrating an example of a hardware configuration of the terminal station device of the communication system according to the embodiment of the present invention.

In the example of FIG. 4, the terminal station device 10 of the communication system according to the embodiment is configured with, for example, a server computer or a personal computer, and includes a hardware processor 111A such as a central processing unit (CPU). In addition, a program memory 111B, a data memory 112, an input/output interface 113, and a communication interface 114 are connected to the hardware processor 111A via a bus 115. The same applies to the subscriber line termination device 20 of the communication system and the management system 50.

The communication interface 114 includes, for example, one or more wireless communication interface units, and enables transmission/reception of information to/from a communication network NW. As the wireless interface, for example, an interface in which a low-power wireless data communication standard such as a wireless local area network (LAN) is adopted is used.

The input/output interface 113 is connected to an input device 200 and an output device 300, which are attached to the terminal station device 10 and are used by the user or the like.

The input/output interface 113 can perform processing of fetching operation data that is input by a user or the like via the input device 200 such as a keyboard, a touch panel, a touchpad, or a mouse, and outputting output data to the output device 300 including a display device using a liquid crystal display, an organic electro luminescence (EL) display, or the like to display the output data. Note that the input device 200 and the output device 300 may be devices included in the terminal station device 10 or may be an input device and an output device of another information terminal that can perform communication with the terminal station device 10 via the network NW.

The program memory 111B is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs required for executing various kinds of control processing according to the embodiment.

The data memory 112 is used as a tangible storage medium, for example, as a combination of the non-volatile memory and a volatile memory such as a random access memory (RAM), and is used to store various kinds of data acquired and created during various kinds of processing.

The terminal station device 10 according to the embodiment of the present invention can be configured as an information processing device including the maintenance function unit 11 and the communication processing unit 12 illustrated in FIG. 1 that are processing function units by software.

Each information storage unit and the storage unit 13 that are used as a working memory or the like by each unit of the terminal station device 10 can be configured by using the data memory 112 of FIG. 4. Here, these configured storage areas are not essential configurations in the terminal station device 10, and may be areas provided in, for example, an external storage medium such as a universal serial bus (USB) memory or a storage device such as a database server provided in a cloud.

All of the processing function units in each of the maintenance function unit 11 and the communication processing unit 12 can be realized by causing the hardware processor 111A to read and execute a program stored in the program memory 111B. Note that some or all of these processing function units may be implemented in other various forms including an integrated circuit such as an application specific integrated circuit (ASIC) or a field-programmable gate array (FPGA).

Further, the method described in each embodiment can be stored in a recording medium such as a magnetic disk (a Floppy (registered trademark) disk, a hard disk, or the like), an optical disc (CD-ROM, DVD, MO, or the like), or a semiconductor memory (a ROM, a RAM, a flash memory, or the like), as a program (software means) that can be executed by a computer, and can be distributed by being transmitted through a communication medium. Note that the program stored on the medium side also includes a setting program for configuring, in the computer, software means (including not only an execution program but also a table and a data structure) to be executed by the computer. The computer that implements the device executes the above-described processing by reading the programs recorded in the recording medium, configuring the software means by the setting program as needed, and controlling operations by the software means. Note that the recording medium in the present specification is not limited to a recording medium for distribution and includes a storage medium such as a magnetic disk or a semiconductor memory provided in the computer or in a device connected via a network.

Note that the present invention is not limited to the embodiment described above, and various modifications can be made at an implementation stage without departing from the gist of the invention. Further, each embodiment may be implemented in an appropriate combination, and in that case, combined effects can be obtained. Furthermore, the embodiments include various types of inventions, and various types of inventions can be extracted by a combination selected from a plurality of disclosed components. For example, in a case where the problems can be solved and the advantageous effects can be obtained even if some components are deleted from all the components described in the embodiment, a configuration from which the components are deleted can be extracted as an invention.

### Reference Signs List

10 Terminal station device
11 Maintenance function unit
11a Distance measurement unit
11b Deterioration estimation unit
12 Communication processing unit
12a Signal intensity measurement unit
13 Storage unit
20 Subscriber line termination device
30 Relay network
40 Higher-level communication network
50 Management system
60 Monitoring control network

1. A terminal station device in a passive optical communication network in which the terminal station device and a subscriber line termination device are connected to each other, the terminal station device comprising:
distance measurement circuitry that measures a distance between the terminal station device and the subscriber line termination device;
signal intensity measurement circuitry that measures an intensity of a signal received from the subscriber line termination device; and
estimation circuitry that estimates an occurrence of a sign of a failure in the subscriber line termination device based on a measurement result of the distance by the distance measurement circuitry and a measurement result of the intensity of the signal by the signal intensity measurement circuitry.

2. The terminal station device according to claim 1, wherein:
the estimation circuitry estimates an occurrence of a sign of a failure in the subscriber line termination device in a case where the distance measured by the distance measurement circuitry is a predetermined distance longer than a normal distance and the intensity measured by the signal intensity measurement circuitry is a predetermined intensity higher than a normal intensity.

3. The terminal station device according to claim 1, wherein:
the estimation circuitry estimates an occurrence of a sign of a failure in the subscriber line termination device in a case where the distance measured by the distance measurement circuitry is a predetermined length shorter than a normal distance and the intensity measured by the signal intensity measurement circuitry is a predetermined intensity lower than a normal intensity.

4. The terminal station device according to claim 1, wherein:
the distance measurement circuitry measures a length of an optical cable between the terminal station device and the subscriber line termination device,
the signal intensity measurement circuitry measures an intensity of an optical signal received from the subscriber line termination device via the optical cable, and
the estimation circuitry estimates an occurrence of a sign of a failure in the subscriber line termination device based on a measurement result of the length of the optical cable by the distance measurement circuitry and a measurement result of the intensity of the optical signal by the signal intensity measurement circuitry.

5. A communication method performed by a terminal station device in a passive optical communication network in which the terminal station device and a subscriber line termination device are connected to each other, the method comprising:
measuring a distance between the terminal station device and the subscriber line termination device;
measuring an intensity of a signal received from the subscriber line termination device; and
estimating an occurrence of a sign of a failure in the subscriber line termination device based on a measurement result of the distance and a measurement result of the intensity of the signal.

6. The communication method according to claim 5, wherein:
the estimating includes estimating an occurrence of a sign of a failure in the subscriber line termination device in a case where the measured distance is a predetermined distance longer than a normal distance and the measured intensity is a predetermined intensity higher than a normal intensity.

7. The communication method according to claim 5, wherein:
the estimating includes estimating an occurrence of a sign of a failure in the subscriber line termination device in a case where the measured distance is a predetermined distance shorter than a normal distance and the measured intensity is a predetermined intensity lower than a normal intensity.

8. A non-transitory computer readable medium storing a communication processing program for causing a processor to perform the method of claim 5.
